(19) United States
(12) Patent Application Publication
(10) Pub. No.: US 2024/0195033 A1
(43) Pub. Date: Jun. 13, 2024

(54) BATTERY

(71) Applicant: TOYOTA JIDOSHA KABUSHIKI KAISHA, Toyota-shi (JP)

(72) Inventor: Kenichi KAKISHITA, Nagoya-shi (JP)

(73) Assignee: TOYOTA JIDOSHA KABUSHIKI KAISHA, Toyota-shi (JP)

(21) Appl. No.: 18/531,196

(22) Filed: Dec. 6, 2023

(30) Foreign Application Priority Data
Dec. 12, 2022 (JP) 2022-198182

(51) Int. Cl. H01M 50/586; H01M 50/105; H01M 50/119; H01M 50/121; H01M 50/122; H01M 50/124; H01M 50/59

(52) U.S. Cl. CPC H01M 50/586; H01M 50/105; H01M 50/119; H01M 50/121; H01M 50/122; H01M 50/124; H01M 50/59

(57) ABSTRACT

A battery including: an electrode body; a terminal that is electrically connected to the electrode body; a laminate film that covers an entire surface of the electrode body and a surface of a portion of the terminal, and that includes at least a metal layer; and a fusing resin layer, serving as a resin layer, which is interposed between the terminal and the metal layer, the fusing resin layer including insulating particles.

### CROSS-REFERENCE TO RELATED APPLICATION

This application is based on and claims priority under 35 USC 119 from Japanese Patent Application No. 2022-198182 filed on Dec. 12, 2022, the disclosure of which is incorporated by reference herein.

### BACKGROUND

### Technical Field

The present disclosure relates to a battery.

### Related Art

A battery such as a lithium-ion secondary battery generally includes an electrode body including a current collector, a positive electrode active material layer, an electrolyte layer, and a negative electrode active material layer. The electrode body is sealed in an internal space surrounded by, for example, an exterior material.

For example, Japanese Patent No. 6796417 discloses a laminate type electric storage element in which an electrode body formed by laminating a sheet-like positive electrode and negative electrode via a separator is tightly sealed together with an electrolyte solution inside an outer package consisting of a laminate film formed in a flattened bag shape, wherein: the electrode terminal plates of the flat plate positive electrode and negative electrode connected to each of the positive electrode and the negative electrode include electrode terminals derived from predetermined edges of the outer package; the laminate film that faces aligned to the outline of the outer package is fused together at peripheral regions surrounding a planar region; the laminate film is formed with an insulating resin layer on both front and back sides of a metal foil base material; end faces of the base material are exposed at the predetermined edges of the outer package; the peripheral regions are fused via a tab film at regions along the predetermined edges; the tab film deviates outward of the outside package at a region of part of the predetermined edges; and the laminate type electric storage element includes a deformed portion formed in a shape covering both the front and back sides of a base end of the electrode terminals.

### SUMMARY

Conventionally, when an electrode body and a terminal in a battery are sealed by a laminate film, a resin layer that is interposed between the terminal and a metal layer in the laminate film is melted into a liquid state. At this time, if an excessive load is applied to a portion of the laminate film, the liquid resin may flow from the place at which the load was applied, and a short circuit may occur due to contact between the metal layer and the terminal.

The present disclosure has been made in consideration of the above circumstances, and an object of the present disclosure is to provide a battery in which a short circuit due to contact between a metal layer and a terminal is suppressed.

A battery of a first aspect of the present disclosure including:
an electrode body;
a terminal that is electrically connected to the electrode body;
a laminate film that includes at least a metal layer and that covers an entire surface of the electrode body and a surface of a portion of the terminal; and
a resin layer that is interposed between the terminal and the metal layer, wherein the resin layer includes insulating particles.

The battery of a second aspect according to the present disclosure is the battery of the first aspect, wherein:
as the resin layer, the laminate film includes a fusing resin layer at a terminal-side surface of the metal layer; and
the fusing resin layer includes the insulating particles.

The battery of a third aspect according to the present disclosure is the battery of the second aspect or the second aspect, wherein:
a fusing resin film that is interposed between the terminal and the laminate film is included as the resin layer; and
the fusing resin film includes the insulating particles.

The present disclosure enables a battery to be provided in which a short circuit due to contact between a metal layer and a terminal is suppressed.

### BRIEF DESCRIPTION OF THE DRAWINGS

FIG. 1 is a schematic perspective view illustrating a battery according to an exemplary embodiment of the present disclosure.

FIG. 2 is a schematic cross-sectional view illustrating a cross section taken along the line X-X in FIG. 1.

FIG. 3 is an enlarged cross-sectional view illustrating an enlarged view of the terminal, the tab film, and the laminate film illustrated in FIG. 2.

FIG. 4 is an enlarged cross-sectional view illustrating a state in which an excessive load is applied to a portion of the terminal, the tab film, or the laminate film illustrated in FIG. 2.

FIG. 5 is an enlarged cross-sectional view illustrating an enlarged view of a terminal, a tab film, and a laminate film of a battery according to another exemplary embodiment of the present disclosure.

FIG. 6 is an enlarged cross-sectional view illustrating an enlarged view of a terminal, a tab film, and a laminate film in a conventional battery.

### DETAILED DESCRIPTION

Detailed explanation follows regarding a battery in the present disclosure, with reference to the drawings. The drawings are schematic representations, and the sizes and shapes of the respective components are exaggerated as appropriate in order to facilitate understanding.

### Battery

### First Exemplary Embodiment

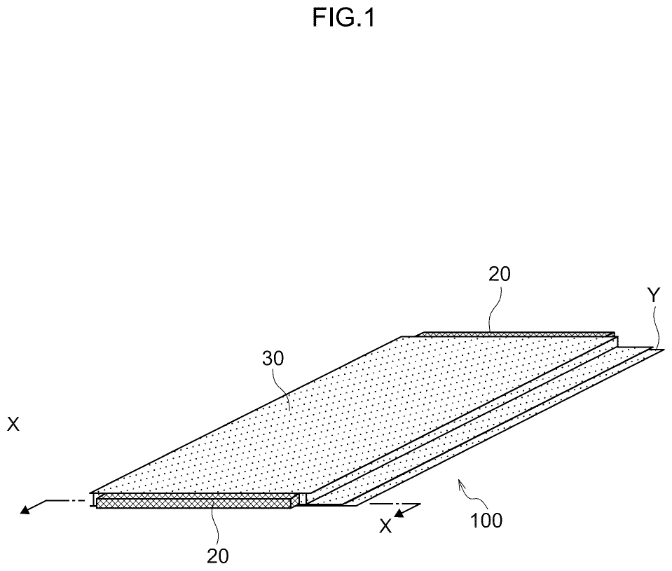

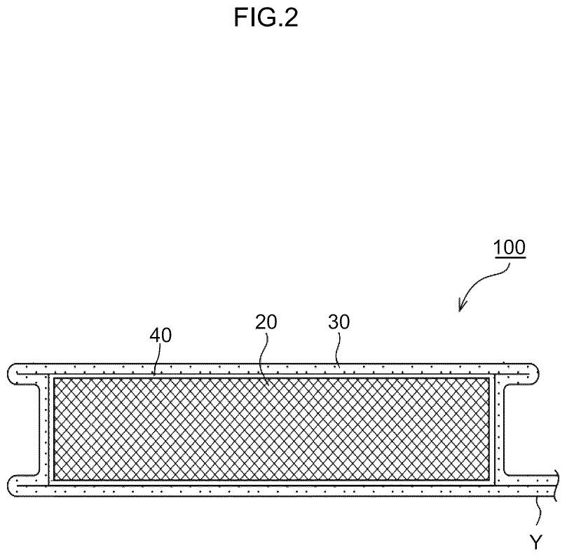

First, explanation follows regarding a battery according to an exemplary embodiment (first exemplary embodiment) of the present disclosure. FIG. 1 is a schematic perspective view illustrating a battery according to the present disclosure. FIG. 2 is a schematic cross-sectional view illustrating a cross section taken along the line X-X in FIG. 1.

The outer periphery of a battery 100 illustrated in FIG. 1 is covered by a laminate film 30. An electrode body is sealed inside the laminate film 30, and the entire surface of the electrode body is covered by the laminate film 30. Moreover, a terminal 20 that is electrically connected to the electrode body is provided at one end side and another end side of the electrode body. As illustrated in FIG. 1 and FIG. 2, a portion of the surface of the terminal 20 is covered by the laminate film 30, and a portion of each of the one end side and the other end side of the terminal 20 is exposed. The laminate film 30 is, for example, a single film, and covers the electrode body and the terminal 20 such that the single laminate film 30 is folded. As illustrated in FIG. 2, the ends of the laminate film 30 are overlapped and fused together to form a fused portion Y. Moreover, tab film 40 which serves as a fusing resin film is interposed between the terminal 20 and the laminate film 30.

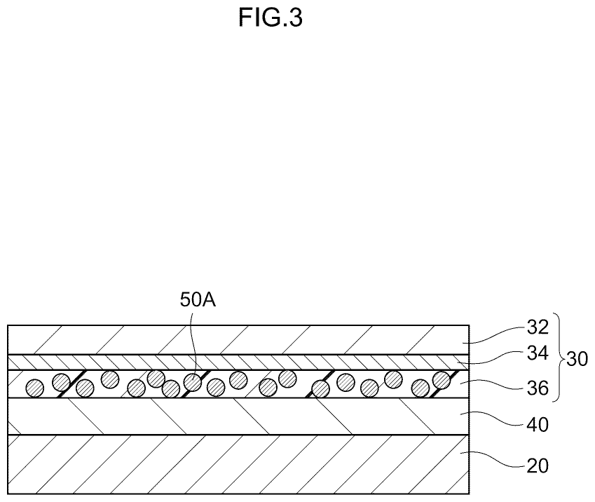

FIG. 3 is an enlarged cross-sectional view illustrating an enlarged view of the terminal 20, the tab film 40, and the laminate film 30 in FIG. 2. The laminate film 30 includes a fusing resin layer 36, a metal layer 34, and a protective layer 32 in this order from the terminal 20 side. Namely, the battery illustrated in FIG. 3 includes the tab film 40 and the fusing resin layer 36 as resin layers interposed between the terminal 20 and the metal layer 34. Further, the fusing resin layer 36 contains insulating particles 50A.

Explanation follows regarding a conventional battery.

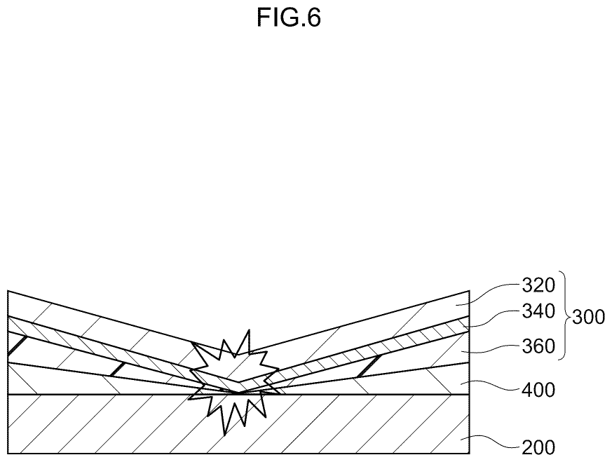

FIG. 6 is an enlarged cross-sectional view illustrating an enlarged view of a terminal, a tab film, and a laminate film in a conventional battery. A conventional battery includes an electrode body (not illustrated), a terminal 200, a laminate film 300 that covers the electrode body and the terminal 200, and a tab film 400 that is interposed between the terminal 200 and the laminate film 300. The laminate film 300 includes a fusing resin layer 360, a metal layer 340, and a protective layer 320 in this order from the terminal 200 side. Note that the tab film 400 and the fusing resin layer 360 which serve as resin layers interposed between the terminal 200 and the metal layer 340 do not contain insulating particles.

In a conventional battery, when a surface of the terminal 200 is sealed by the laminate film 300, the tab film 400 and the fusing resin layer 360, which serve as resin layers, are melted into a liquid state. At this time, when an excessive load is applied to a part of the laminate film 300, the resin, which has become into a liquid state, flows from the place at which the load was applied, and as illustrated in FIG. 6, the metal layer 340 of the laminate film 300 and the terminal 200 may come into contact with each other, which results in a short circuit. Note that in a case in which a slight protrusion (a so-called burr) is present at the terminal 200, a short circuit is likely to occur even if the resin which has become into a liquid state flows only slightly. Moreover, if the heating temperature during sealing by the laminate film 300 is increased and the viscosity of the molten resin is too low, flow of the resin is easily generated, and a short circuit is likely to occur. Under these circumstances, it was not easy to suppress a short circuit due to contact between the metal layer 340 and the terminal 200 even if an attempt was made to apply a load uniformly so as not to apply an excessive load to a portion of the laminate film 300 during sealing.

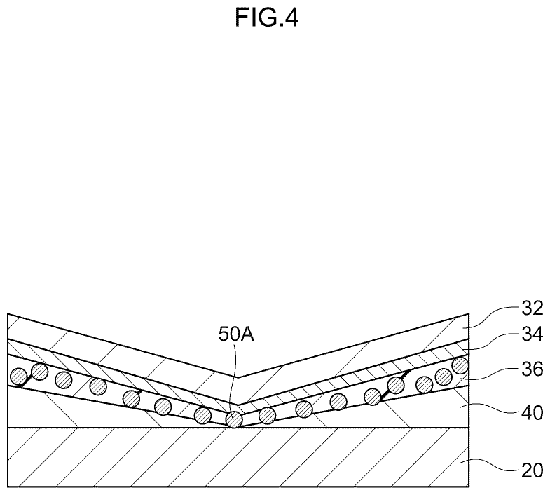

In contrast, the battery illustrated in FIG. 3 includes insulating particles 50A in the fusing resin layer 36. Accordingly, even if an excessive load is applied to a portion of the laminate film 30 and the resin which has become into a liquid state flows from the place at which the load was applied, as illustrated in FIG. 4, the insulating particles 50A are interposed between the metal layer 34 of the laminate film 30 and the terminal 20. This prevents contact between the metal layer 34 and the terminal 20, thereby suppressing a short circuit between the metal layer 34 and the terminal 20.

Moreover, the inclusion of the insulating particles 50A enables the thickness of the fusing resin layer 36 after sealing to be suppressed from becoming smaller than the particle diameter of the insulating particles 50A. This enables the thickness of the fusing resin layer 36 to be uniform, and also enables the thickness of the entire laminate film 30 to be uniform. Note that the fused portion Y illustrated in FIG. 1 may be bent in order to improve the structural efficiency of the battery 100. At this time, since the thickness of the entire laminate film 30 is uniform, the occurrence of portions that cause folding defects is suppressed, and excellent folding properties can be obtained.

### Modified Example

Although in the battery illustrated in FIG. 2 and FIG. 3, an aspect in which the tab film 40 is provided between the laminate film 30 and the terminal 20 is illustrated, there is no limitation thereto. Namely, the tab film 40 may not be provided, and the laminate film 30 and the terminal 20 may be in direct contact with each other.

Although in the battery illustrated in FIG. 1, an aspect in which the electrode body and the terminal 20 are covered by a single laminate film 30 is illustrated, there is no limitation thereto, and the electrode body and the terminal may be sealed by plural laminate films. For example, in a case in which the electrode body and the terminal are sealed by two laminate films, the entire surface of the electrode body and a surface of a portion of the terminal are covered by the two laminate films from one side and another side in a thickness direction of the electrode body, and the ends of the two laminate films can be sealed by fusing.

Note that in a battery in which the end portions of two laminate films are fused together from one side and the other side in the thickness direction of the electrode body by using the two laminate films so as to cover the electrode body and the terminal, including insulating particles in the fusing resin layer of the laminate film enables the occurrence of a short circuit in the entire battery to be suppressed. In a case in which one of the two laminate films is short-circuited to the positive electrode of the electrode body, and the other laminate film is short-circuited to the negative electrode, the two laminate films are also short-circuited, and a short circuit may occur in the entire battery, which is undesirable. However, by including insulating particles in the fusing resin layer of the two laminate films, a short circuit between the two laminate films can be suppressed, and as a result, the occurrence of a short circuit in the entire battery can be suppressed.

### Second Exemplary Embodiment

Next, explanation follows regarding a battery according to another exemplary embodiment (second exemplary embodiment) of the present disclosure.

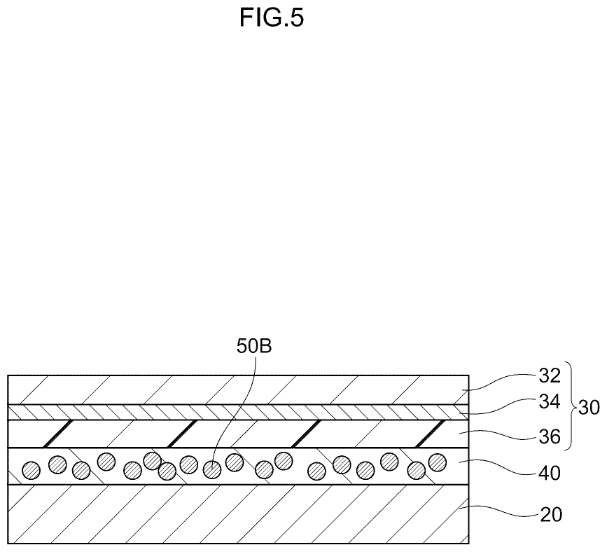

FIG. 5 is an enlarged cross-sectional view illustrating an enlarged view of a terminal, a tab film, and a laminate film of a battery according to another exemplary embodiment of the present disclosure.

The battery illustrated in FIG. 5 includes an electrode body (not illustrated), a terminal 20, a laminate film 30 that covers the electrode body and the terminal 20, and a tab film 40 that is interposed between the terminal 20 and the laminate film 30. The laminate film 30 includes a fusing resin layer 36, a metal layer 34, and a protective layer 32 in this order from the terminal 20 side. Namely, the battery illustrated in FIG. 5 includes the tab film 40 and the fusing resin layer 36 as resin layers interposed between the terminal 20 and the metal layer 34. The tab film 40 includes insulating particles 50B.

Since the battery illustrated in FIG. 5 includes the insulating particles 50B in the tab film 40, even if an excessive load is applied to a portion of the laminate film 30 and the resin which has become into a liquid state flows from the place at which the load was applied, the insulating particles 50B are interposed between the metal layer 34 of the laminate film and the terminal 20. This prevents contact between the metal layer 34 and the terminal 20, thereby suppressing a short circuit between the metal layer 34 and the terminal 20.

Moreover, in the battery illustrated in FIG. 5, since the insulating particles 50B are included in the tab film 40 that is provided around the terminal 20, the amount of insulating particles can be reduced in comparison to a case in which the insulating particles are included in the fusing resin layer 36 of the laminate film 30 that covers a part of the surface of the terminal 20 and the entire surface of the electrode body.

### Parts of the Battery

Next, explanation follows regarding the respective parts that configure the battery of the present disclosure.

### Laminate Film

The laminate film of the present disclosure preferably includes at least a metal layer, and further includes a fusing resin layer at a surface of the metal layer at a terminal side. Note that the fusing resin layer corresponds to a resin layer interposed between the terminal and the metal layer. Alternatively, the laminate film may include a protective layer at a surface of the metal layer opposite to the terminal.

Examples of materials for the fusing resin layer include olefin resins such as polypropylene (PP), polyethylene (PE), and the like. Examples of materials for the metal layer include aluminum, aluminum alloys, and stainless steel. Examples of materials for the protective layer include polyethylene terephthalate (PET) and nylon.

The thickness of the fusing resin layer is preferably, for example, greater than or equal to 20 μm and less than or equal to 100 μm, more preferably greater than or equal to 20 μm and less than or equal to 60 μm, and still more preferably greater than or equal to 40 μm and less than or equal to 60 μm. The thickness of the metal layer is, for example, greater than or equal to 30 μm and less than or equal to 60 μm. The thickness of the protective layer is, for example, greater than or equal to 20 μm and less than or equal to 60 μm. The thickness of the entire laminate film is, for example, greater than or equal to 70 μm and less than or equal to 220 μm.

### Tab Film

The battery of the present disclosure preferably includes a fusing resin film (a so-called tab film) that is interposed between the terminal and the laminate film. Note that the fusing resin film corresponds to a resin layer interposed between the terminal and the metal layer. The fusing resin film is provided so as to cover a surface of a portion of the terminal and so as to be interposed between the terminal and the laminate film.

Examples of materials for the fusing resin film include olefin resins such as polypropylene (PP), polyethylene (PE), and the like. The thickness of the fusing resin film is preferably, for example, greater than or equal to 20 μm and less than or equal to 100 μm, more preferably greater than or equal to 20 μm and less than or equal to 60 μm, and still more preferably greater than or equal to 40 μm and less than or equal to 60 μm.

Note that the thickness of the resin layer interposed between the terminal and the metal layer, which is a layer containing insulating particles (such as a fusing resin film or a fusing resin layer in a laminate film) is preferably greater than or equal to 20 μm and less than or equal to 100 μm, more preferably greater than or equal to 20 μm and less than or equal to 60 μm, and still more preferably greater than or equal to 40 μm and less than or equal to 60 μm.

Note that the thickness of each layer is an average of measured values at 10 arbitrarily selected points.

### Insulating Particles

The insulating particles are included in a resin layer (for example, a fusing resin film or a fusing resin layer in a laminate film) which is interposed between the terminal and the metal layer. Insulation in the insulating particles means a property of not passing electricity, specifically meaning that the volume resistivity of the material of the insulating particles is 10¹⁴ Ω·cm or greater. The volume resistivity of a material can be measured by a method specified in JIS C2141:1992.

Examples of the insulating particles include inorganic particles and metal oxide particles, and preferably include one or more particles selected from these groups. Note that although there is no particular limitation to the shape of the insulating particles, from the standpoint of efficiently suppressing a short circuit between the metal layer and the terminal, the shape of the insulating particles is preferably a spherical shape.

The average particle diameter of the insulating particles is preferably greater than or equal to 30 μm and less than or equal to 50 μm, and more preferably greater than or equal to 35 μm and less than or equal to 45 μm from the standpoint of efficiently suppressing a short circuit between the metal layer and the terminal.

Note that the average particle diameter of the insulating particles is defined as the average particle diameter by capturing an SEM image of a cross section of the resin layer including the insulating particles, measuring the maximum diameter of 50 arbitrarily selected insulating particles, and obtaining the average value thereof.

The average spacing between the insulating particles contained in the resin layer is preferably greater than or equal to 100 μm and less than or equal to 1000 μm, and more preferably greater than or equal to 200 μm and less than or equal to 500 μm, from the standpoint of efficiently suppressing a short circuit between the metal layer and the terminal.

Note that the average spacing between the insulating particles is defined as the average spacing by capturing an SEM image of a cross section of the resin layer including the insulating particles, measuring the spacing (i.e., the shortest distance) between 50 arbitrarily selected pairs of adjacent insulating particles, and calculating the average value of the spacings.

For example, it is preferable that the average thickness of a layer including the insulating particles, which is the resin layer interposed between the terminal and the metal layer, is greater than or equal to 20 μm and less than or equal to 60 μm, the average particle diameter of the insulating particles is greater than or equal to 30 μm and less than or equal to 50 μm, and the average spacing between the insulating particles is greater than or equal to 100 μm and less than or equal to 1000 μm.

### Electrode Body

An electrode body in the present disclosure generally includes a positive electrode current collector, a positive electrode active material layer, an electrolyte layer, a negative electrode active material layer, and a negative electrode current collector in this order in a thickness direction.

The positive electrode active material layer contains at least a positive electrode active material. The positive electrode active material layer may further contain at least one of a conductive material, an electrolyte, or a binder. The shape of the positive electrode active material is, for example, particulate. Examples of the positive electrode active material include an oxide active material. Alternatively, sulfur (S) may be used as the positive electrode active material.

The positive electrode active material preferably includes a lithium composite oxide. The lithium composite oxide may contain at least one selected from the group consisting of F, Cl, N, S, Br, and I. Further, the lithium composite oxide may have a crystal structure belonging to at least one space group selected from the space groups R-3m, Immm or P63-mmc (also referred to as P63mc, P6/mmc). Alternatively, the lithium composite oxide may have an O2 structure in which a main sequence of a transition metal, oxygen, and lithium are provided.

Examples of the lithium composite oxide having a crystalline structure belonging to R-3m include compounds represented by LiₓMe_{y}O_{α}X_{β} (Me representing at least one selected from the group consisting of Mn, Co, Ni, Fe, Al, Cu, V, Nb, Mo, Ti, Cr, Zr, Zn, Na, K, Ca, Mg, Pt, Au, Ag, Ru, W, B, Si, and P, X representing at least one selected from the group consisting of F, Cl, N, S, Br, and I, and 0.5≤x≤1.5, 0.5≤y≤1.0, 1≤α<2, and 0<β1≤1 being satisfied).

Examples of the lithium composite oxide having a crystalline structure belonging to Immm include composite oxide compounds represented by Liₓ₁M¹A¹₂ (1.5≤x≤2.3 being satisfied, M¹ including at least one selected from the group consisting of Ni, Co, Mn, and Fe, A¹ including at least oxygen, and oxygen accounting for 85 atom % or more in A¹) (as a specific example, Li₂NiO₂), and composite oxide compounds represented by Liₓ₁M^{1A}₁₋ₓ₂M^{1B}ₓ₂O_{2-y}A²_{y} (with 0≤x2≤0.5 and 0≤y≤0.3, at least one of x2 or y not being 0, M^{1A} representing at least one selected from the group consisting of Al, Mg, Sc, Ti, Cr, V, Zn, Ga, Zr, Mo, Nb, Ta, and W, and A2 representing at least one selected from the group consisting of F, Cl, Br, S, and P).

Examples of the lithium oxide composite having a crystalline structure belonging to P63-mmc include composite oxide compounds represented by an M1ₓM2_{y}O₂ (M1 representing an alkali metal (at least one of Na or K is preferable), M2 representing a transition metal (at least one selected from the group consisting of Mn, Ni, Co, and Fe is preferable), and x+y satisfying 0<x+y≤2).

Examples of the lithium composite oxide having an 02 structure include composite oxide compounds represented by Liₓ[Li_{α}(MnₐCo_{b}M_{c})_{1-α}]O₂ (with 0.5<x<1.1, 0.1<α<0.33, 0.17<a<0.93, 0.03<b<0.50, and 0.04<c<0.33, and M representing at least one selected from the group consisting of Ni, Mg, Ti, Fe, Sn, Zr, Nb, Mo, W, and Bi), and as a specific example, Li_{0.74}4[Li_{0.145}Mn_{0.625}Co_{0.115}Ni_{0.115}]O₂.

Note that the positive electrode preferably includes, in addition to the positive electrode active material, a solid material selected from the solid electrolyte group consisting of a sulfide solid electrolyte material, an oxide solid electrolyte material, and a halide solid electrolyte material, and an aspect in which at least a portion of a surface of the positive electrode active material is covered with a sulfide solid electrolyte material, an oxide solid electrolyte material, or a halide solid electrolyte material is more preferable. As a halide solid electrolyte material covering at least a part of a surface of the positive electrode active material, Li_{6-(4x)b}(Ti₁₋ₓAlₓ)_{b}F₆ (0<x<1, 0<b≤1.5) (LTAF electrolyte) is preferable.

Examples of the conductive material include a carbon material. The electrolyte may be a solid electrolyte or may be a liquid electrolyte. The solid electrolyte may be an organic solid electrolyte such as a gel electrolyte, or an inorganic solid electrolyte such as an oxide solid electrolyte material or a sulfide solid electrolyte material. Moreover, the liquid electrolyte (electrolyte) includes, for example, a supporting salt such as LiPF₆, and a solvent such as a carbonate-based solvent. Examples of the binder include a rubber binder and a fluoride binder.

The negative electrode active material layer contains at least a negative electrode active material. The negative electrode active material layer may further contain at least one of a conductive material, an electrolyte, or a binder. Examples of the negative electrode active material include a metallic active material such as Li or Si, a carbon active material such as graphite, and an oxide active material such as a Li₄Ti₅O₁₂. The shape of the negative electrode active material is, for example, a particulate shape or a foil shape. The conductive material, the electrolyte, and the binder are the same as those described above.

The electrolyte layer is disposed between the positive electrode active material layer and the negative electrode active material layer, and contains at least an electrolyte. The electrolyte may be a solid electrolyte or may be a liquid electrolyte. The electrolyte layer is preferably a solid electrolyte layer. The electrolyte layer may include a separator.

The solid electrolyte preferably includes at least one solid electrolyte selected from the solid electrolyte group consisting of a sulfide solid electrolyte material, an oxide solid electrolyte material, and a halide solid electrolyte material.

As the sulfide solid electrolyte material, sulfur (S) is preferably contained as a main component of the anionic element, and more preferably, for example, Li element, A element, and S element are contained. The element A is at least one selected from the group consisting of P, As, Sb, Si, Ge, Sn, B, Al, Ga, and In. The sulfide solid electrolyte material may further contain at least one of O or a halogen element. Examples of the halogen element (X) include F, Cl, Br, I, and the like. The composition of the sulfide solid electrolyte material is not particularly limited, and examples include xLi₂S·(100-x)P₂S₅ (70≤x≤80) and yLiI·zLiBr·(100-y-z)(xLi₂S·(1-x)P₂S₅) (0.7≤x≤0.8, 0≤y≤30, 0≤z≤30). The sulfide solid electrolyte material may have a composition represented by the following general formula (1).

Li₄₋ₓGe₁₋ₓPₓS₄ (0<x<1) Formula (1):

In Formula (1), at least a portion of Ge may be substituted with at least one selected from the group consisting of Sb, Si, Sn, B, Al, Ga, In, Ti, Zr, V, and Nb. Further, at least a portion of P may be substituted with at least one selected from the group consisting of Sb, Si, Sn, B, Al, Ga, In, Ti, Zr, V, and Nb. A portion of Li may be substituted with at least one selected from the group consisting of Na, K, Mg, Ca, and Zn. A portion of S may be substituted with halogen. The halogen is at least one of F, Cl, Br, or I.

As the oxide solid electrolyte material, oxygen (O) is preferably included as a main component of the anionic element, and for example, Li, Q element (Q representing at least one of Nb, B, Al, Si, P, Ti, Zr, Mo, W, or S), and O may be contained. Examples of the oxide solid electrolyte material include a garnet-type solid electrolyte, a perovskite-type solid electrolyte, a nasicon-type solid electrolyte, a Li—P—O based solid electrolyte, and a Li—B—O based solid electrolyte. Examples of the garnet-type solid electrolyte include Li₇La₃Zr₂O₁₂, Li₇₋ₓLa₃(Zr₂₋ₓNbₓ)O₁₂ (0≤x≤2), and Li₅La₃Nb₂O₁₂. Examples of the perovskite-type solid electrolyte include (Li, La)TiO₃, (Li, La)NbO₃, (Li, Sr)(Ta, Zr)O₃, and the like. Examples of the nasicon-type solid electrolyte include Li(Al, Ti)(PO₄)₃, Li(Al, Ga)(PO₄)₃, and the like. Examples of the Li—P—O based solid electrolyte include Li₃PO₄, LIPON (a compound in which a portion of O in the Li₃PO₄ is substituted with N), and examples of the Li—B—O based solid electrolyte include Li₃BO₃, a compound in which a portion of O in the Li₃BO₃ is substituted with C, and the like.

As the halide solid electrolyte material, a solid electrolyte containing Li, M, and X (M representing at least one of Ti, Al, or Y, and X representing F, Cl, or Br) is suitable. More specifically, Li_{6-3z}Y_{z}X₆ (X representing Cl or Br, and z satisfying 0<z<2), and Li_{6-(4-x)b}(Ti₁₋ₓAlₓ)_{b}F₆ (0<x<1, 0<b≤1.5) is preferable. Among Li_{6-3z}Y_{z}X₆, Li₃YX₆ (X representing Cl or Br) is more preferable in terms of excellent lithium-ion conductivity, and further, Li₃YCl₆ is preferable. Moreover, Li_{6-(4-x)b}(Ti₁₋ₓAlₓ)_{b}F₆ (0<x<1, 0<b≤1.5) is preferably included together with a solid electrolyte such as a sulfide solid electrolyte material from the standpoint of suppressing oxidative decomposition of the sulfide solid electrolyte material, for example.

The positive electrode current collector performs current collection of the positive electrode active material layer. Examples of the positive electrode current collector include stainless steel, aluminum, nickel, iron, titanium, carbon, and the like, and an aluminum alloy foil or an aluminum foil is preferable. The aluminum alloy foil and the aluminum foil may be manufactured using powder. The shape of the positive electrode current collector is, for example, a foil shape or a mesh shape. The positive electrode current collector may include a positive electrode tab for connecting to the positive electrode current collection terminal.

The negative electrode current collector performs current collection of the negative electrode active material layer. Examples of materials for the negative electrode current collector include metals such as copper, SUS, and nickel. Examples of shapes of the negative electrode current collector include a foil shape and a mesh shape. The negative electrode current collector may include a negative electrode tab for connecting to the negative electrode current collector terminal.

### Terminal

The terminal in the present disclosure is disposed at a side surface of the electrode body. Examples of the terminal include a current collecting terminal. A current collecting terminal refers to a terminal that includes a current collecting portion at least partially. The current collecting portion is electrically connected to, for example, a tab of the electrode body. The entire current collecting terminal may be a current collecting portion, or a part thereof may be a current collecting portion. Examples of materials for the terminal include metals such as SUS.

### Battery

The battery in the present disclosure is typically a lithium-ion secondary battery. Examples of applications of the battery include a power source of a hybrid vehicle (HEV), a plug-in hybrid vehicle (PHEV), an electric vehicle (BEV), a gasoline vehicle, a diesel vehicle, or the like. In particular, it is preferable to use the battery in the present disclosure for a power source for driving a hybrid vehicle (HEV), a plug-in hybrid vehicle (PHEV), or an electric vehicle (BEV). Further, the battery in the present disclosure may be used as a power source for a mobile body other than a vehicle (for example, rail, ship, or aircraft), or may be used as a power source for an electric product such as an information processing device.

The present disclosure is not limited to the above-described exemplary embodiments. The above-described exemplary embodiments are examples, and any configuration that has substantially the same configuration as the technical idea set forth in the claims of the present disclosure, and that exhibits similar operational and advantageous effects, is encompassed by the technical scope of the present disclosure.

Effects of the battery according to the present disclosure have been confirmed by experiments.

In Experimental Example 1, a battery having the configuration illustrated in FIG. 3 was prepared. Namely, a battery was prepared including an electrode body, a terminal 20, a laminate film 30 covering the electrode body and the terminal 20, and a tab film 40 interposed between the terminal 20 and the laminate film 30, the laminate film 30 including a fusing resin layer 36, a metal layer 34, and a protective layer 32 in this order from the terminal 20 side. Note that the fusing resin layer 36 contains the insulating particles 50A.

In Experimental Example 2, a battery having the configuration illustrated in FIG. 5 was prepared. Namely, a battery having the same layer configuration as the battery illustrated in FIG. 3, but including insulating particles in the tab film 40 instead of the fusing resin layer 36, was prepared.

As a comparative example, a battery having the configuration illustrated in FIG. 6 was prepared. Namely, a battery that had the same layer configuration as the battery illustrated in FIG. 3, and did not contain insulating particles in either the fusing resin layer 36 or the tab film 40, was prepared.

Regarding the batteries of Experimental Example 1, Experimental Example 2, and the Comparative Example, whether or not a short circuit occurred due to contact between the terminal and the metal layer during fusing (sealing) of the laminate film around the terminal was confirmed. Moreover, the thickness of the portion around the terminal at which the tab film and the laminate film were fused (particularly in cases in which a short circuit occurred, the thickness of the portion at which the short circuit occurred, and the seal thickness) was measured. The results are shown in Table 1.

TABLE 1

| | | Comparative | Experimental | Experimental |
|---|---|---|---|---|
| | | Example | Example 1 | Example 2 |
| Fusing Resin Layer | | No particles | No particles | Particles |
| Tab Film | | No particles | Particles | No particles |
| Result | Short Circuit | Yes | No | No |
| | Seal Thickness (μm) | 0 to 10 | 50 to 60 | 50 to 60 |

As shown in Table 1, it is understood that occurrence of a short circuit was suppressed in Experimental Example 1 and Experimental Example 2 in which the fusing resin layer 36 or the tab film, which is a resin layer interposed between the terminal and the metal layer, contained insulating particles.

### REFERENCE NUMBERS

20, 200 terminal
30, 300 laminate film
32, 320 protective layer
34, 340 metal layer
36, 360 fusing resin layer
40, 400 tab film
50A, 50B insulating particles
100 battery

What is claimed is:

1. A battery comprising:
an electrode body;
a terminal that is electrically connected to the electrode body;
a laminate film that includes at least a metal layer and that covers an entire surface of the electrode body and a surface of a portion of the terminal; and
a resin layer that is interposed between the terminal and the metal layer,
wherein the resin layer includes insulating particles.

2. The battery according to claim 1, wherein:
as the resin layer, the laminate film includes a fusing resin layer at a terminal-side surface of the metal layer; and
the fusing resin layer includes the insulating particles.

3. The battery according to claim 1, wherein:
a fusing resin film that is interposed between the terminal and the laminate film is included as the resin layer; and
the fusing resin film includes the insulating particles.
